(19) United States
(12) Patent Application Publication
(10) Pub. No.: US 2011/0266724 A1
(43) Pub. Date: Nov. 3, 2011

(54) METHOD FOR MANUFACTURING MICROSTRUCTURED METAL OR CERAMIC PARTS FROM FEEDSTOCK

(75) Inventors: Ralph A. Hulseman, Greenville, SC (US); Andrew H. Cannon, Columbia, SC (US); William P. King, Champaign, IL (US); March Maguire, Clemson, SC (US); David Mammarella, Greenville, SC (US)

(73) Assignee: Hoowaki, LLC, Pendleton, SC (US)

(21) Appl. No.: 12/915,351

(22) Filed: Oct. 29, 2010

Related U.S. Application Data
(60) Provisional application No. 61/353,467, filed on Jun. 10, 2010.

(30) Foreign Application Priority Data
May 8, 2009 (US) PCT/US09/43306
May 8, 2009 (US) PCT/US09/43307
Jul. 2, 2009 (US) PCT/US09/49565

(51) Int. Cl. C04B 35/64; B28B 1/087; B29C 33/38

(52) U.S. Cl. 264/603; 264/224; 425/175

(57) ABSTRACT

A method of manufacturing a production part having microstructured features comprising the steps of fabricating a microstructured prototype having microstructured features, manufacturing a microstructured intermediate from the microstructured prototype so that the microstructured intermediate carries a negative of the microstructured features, attaching the microstructured intermediate to a manufacturing tool thereby providing microstructured features on a manufacturing tool, providing feedstock containing material from the group comprising of: metal, ceramic, binder, and any combination of these and manufacturing the production part from the feedstock, using the manufacturing tool and using a process from the group consisting of: compression molding, roll forming, stamping, embossing, extrusion injection molding, and any combination of these.

### CROSS-REFERENCE TO RELATED APPLICATIONS

This application claims the benefit of and priority of U.S. Patent Application Ser. No. 61/353,467 filed Jun. 10, 2010, and U.S. Patent Application Ser. No. 12/813,833 filed Jun. 11, 2010, which claims priority of PCT Application Ser. No. US09/49565 filed Jul. 2, 2009, PCT Patent Application Ser. No. US09/43306 filed May 8, 2009, and PCT Patent Application Ser. No. US09/43307 filed May 8, 2009, all incorporated in their entirety herein by reference.

### BACKGROUND OF THE INVENTION

1. Field of the Invention

This invention is directed to a manufacturing tool, particularly a manufacturing tool having a curved surface and a method of manufacturing a production part having microstructured features from feedstock containing metal, ceramic, binder, or any combination of these.

2. Description of Related Art

In certain types of molding, powder material is pressed by a rigid mold to form a “green part”. One form of powder material can be formed through the atomization of molten metal to form a metal powder. Metals that can be used for the powder include ferrous and non-ferrous metals. The powder material can include a binder for easier molding and demolding, and the binder can be made of wax or polymer. If a binder is present, the “green part” can be placed into a solvent, acid vapor or other corrosive material where the binder is debound from the powder material. Then the powder material can be sintered to coalesce the metal or ceramic into a solid.

Processes that use a manufacturing part to produce the “green part” (“powder molding”) include injection molding, compression molding, roll forming, stamping, embossing, extrusion, or any combination of these. Ceramics that can be included in the powder material include aluminum oxide, aluminum oxide with zirconia, and zirconium oxide with yttrium oxide. Metals that can be included in the powder material include low alloy steels, stainless steels, tool steels, soft magnetic alloys, copper, copper-tungsten blends, and other special alloys. Low alloy steels that can be processed by powder molding include FN02, FN0205, 4605, FN08, 8620, 42CrMo4, 4340, 100Cr6, and 1010. Stainless steels that can be processed by powder molding include 316L, PANACEA, 430, 17-4PH, 420, 310, 440B, and 440Nb. Tool steel that can be processed with powder molding include M2. Soft magnetic alloys that can be processed with powder molding include Iron, FeSi3, and FN50. Other special alloys that can be processed with powder molding include Titanium, Tungsten, F15, HX, N90, and GHS-4, or combinations of the above.

When powder molding parts that include microstructures, traditionally, the process is severely limited by the state of the art. Traditionally, microstructures are imparted on silicon wafers. The use of silicon is necessary to achieve sufficient resolution of microstructures. Processes of imparting microstructures on silicon wafers, such as photolithography, however, severely limit the wafer size. Typically, the wafer size is limited to under twelve inches in diameter and very expensive to manufacture. Further, silicon wafers are rigid, brittle and cannot be conformed to curved surfaces as silicon wafers are flat.

Unfortunately, the state of the art has not sufficiently advanced to allow for the ability to place microstructures on production parts made from powdered material absent the use of silicon wafers or plates. Severe limitation of the type of production part that can be made exist since silicon is relatively expensive, brittle with low impact strengths, does not conform to curved surfaces, has size limitations, is flat and does not always survive demolding. Further, attempts to overcome these size limitations by using multiple silicon wafers or plates leads to undesirable and misaligned microstructures caused by a gap between two plates which causes misalignment, tilt, and height differences.

Further, the inability of the state of the art to impart microstructures on a flexible polymer makes the current invention non-obvious to one skilled in the art. The present invention incorporates by reference the technology from PCT Application PCT/US09/43307 for providing a flexible polymer intermediate unique to the applicant and, therefore, novel and non-obvious to the art.

To provide production parts having curved surfaces, it would be advantageous to provide for a manufacturing part that used a flexible polymer intermediate, instead of silicon, to generate parts with microstructured surfaces, particularly those having curved portions.

To advance the art, an object of the present invention is to provide for a manufacturing part that can impart microstructured features on a production part having a curved portion.

Another object of the present invention is to produce a production part having a curved portion of its surface and having microstructured features.

### SUMMARY OF THE INVENTION

These objects and other advantages of the present invention are achieve by providing a method of manufacturing a production part having microstructured features comprising the steps of: fabricating a microstructured prototype having microstructured features; manufacturing a microstructured intermediate from the microstructured prototype so that the microstructured intermediate carries a negative of the microstructured features; attaching the microstructured intermediate to a manufacturing tool thereby providing microstructured features on a manufacturing tool; providing feedstock containing material from the group comprising of: metal, ceramic, binder, and any combination of these; and, manufacturing the production part from the feedstock, using the manufacturing tool and using a process from the group consisting of: compression molding, roll forming, stamping, embossing, extrusion, injection molding, and any combination of these.

The invention includes providing a manufacturing tool for manufacturing a production part comprising: a substrate used in a manufacturing process from the group consisting of: compressing molding, roll forming, stamping, embossing, extrusion, injection molding, and any combination of these; and, a flexible polymer intermediate having a negative of microstructured features included along a surface of the flexible polymer intermediate carried by the substrate.

Further, the invention includes providing a production part having surface properties selected from the group consisting of: hydrophobicity, hydrophilicity, self-cleaning ability, hydro-dynamics drag coefficients, aerodynamic drag coefficients, frictional properties, optical effects, heat transfer, adhesion, discrete surface area, discrete surface volume, nucleation, cavitation, lubrication, cell growth properties, anti-biofilm growth, tissue adhesion, crack initiation resistance, and any combination of these. The flexible polymer intermediate can be manufactured from a microstructured prototype manufactured by providing a semiconductor wafer, patterning the semiconductor wafer with a negative of the microstructures, molding an uncured flexible polymer to the patterned semiconductor wafer, curing the polymer, thereby forming a microstructured flexible polymer having the microstructured features, removing the microstructured flexible polymer from the patterned semiconductor wafer and deforming at least a portion of the microstructured flexible polymer so as to conform the microstructured flexible polymer to at least a portion of the surface of the one or more macro scale features of the flexible polymer intermediate. The invention can include a second flexible polymer intermediate having a negative of second microstructured features carried by the substrate so that a resulting production part manufactured using the substrate will have a plurality of microstructured features.

The manufacturing tool can include a plurality of flexible polymer intermediates carried by the substrate in a tile arrangement and the substrate can have a curved surface. The flexible polymer intermediates carried by the substrate can be in a non-contiguous arrangement, contiguous arrangement or tiled. In one embodiment, the “green part” and the flexible polymer intermediate are demolded from a mold together whereby the flexible polymer intermediate is carried by the “green part” after ejection; and, the flexible polymer intermediate is removed from the “green part” by debinding. Further, the mold can be removed in debinding, so the “green part” does not need to be demolded at all. Further, the green part can be demolded from the flexible polymer intermediate and then debound.

### DESCRIPTION OF THE DRAWINGS

The invention is described and better understood by referring to the accompanying drawings that are incorporated into the specification:

FIG. 1 is a schematic of one method of practicing the invention using injection molding;

FIG. 2 is a perspective drawing of aspects of the invention;

FIGS. 3A through 3E are schematics of aspects of the present invention;

FIGS. 4A through 4C are schematics of aspects of the present invention;

FIG. 5 is a flow chart of the present invention;

FIGS. 6A through 6B are schematics of aspects of the present invention;

FIG. 7 are schematics of the aspects of the present invention; and,

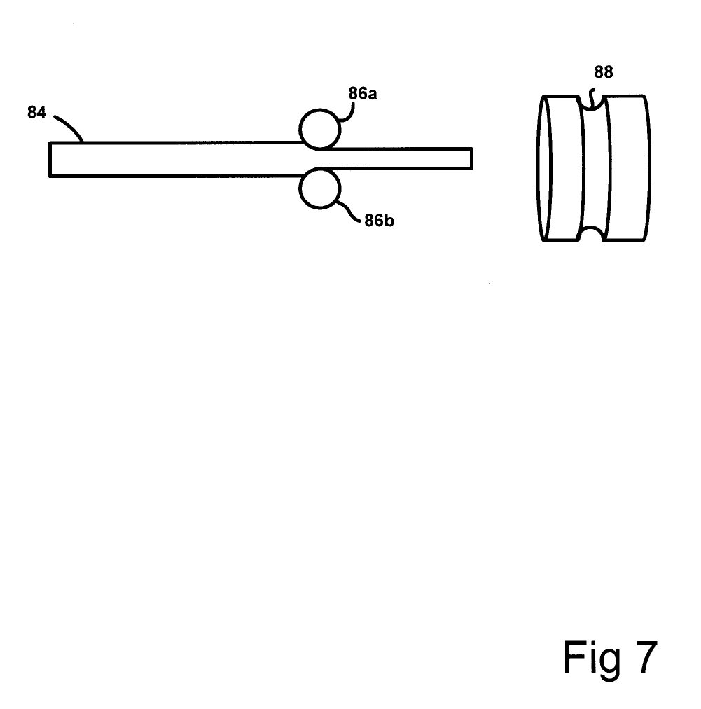

FIG. 8 are schematics of the aspects of the present invention.

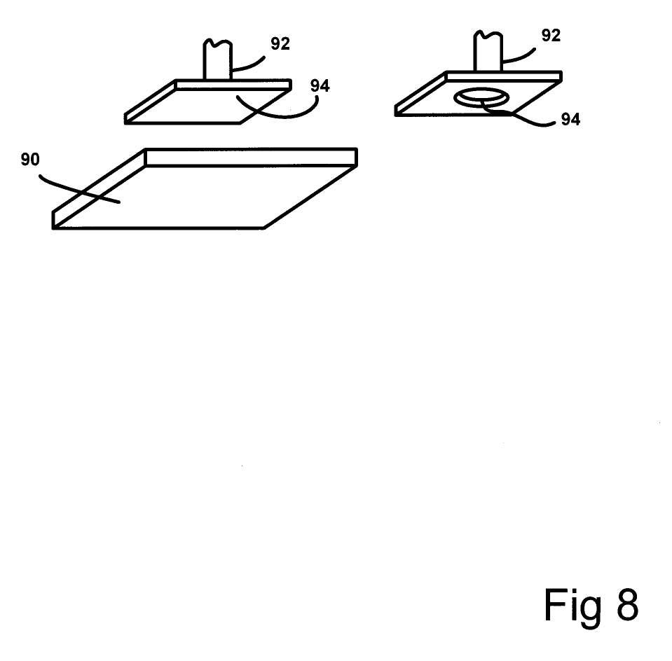

### DETAILED DESCRIPTION OF THE INVENTION

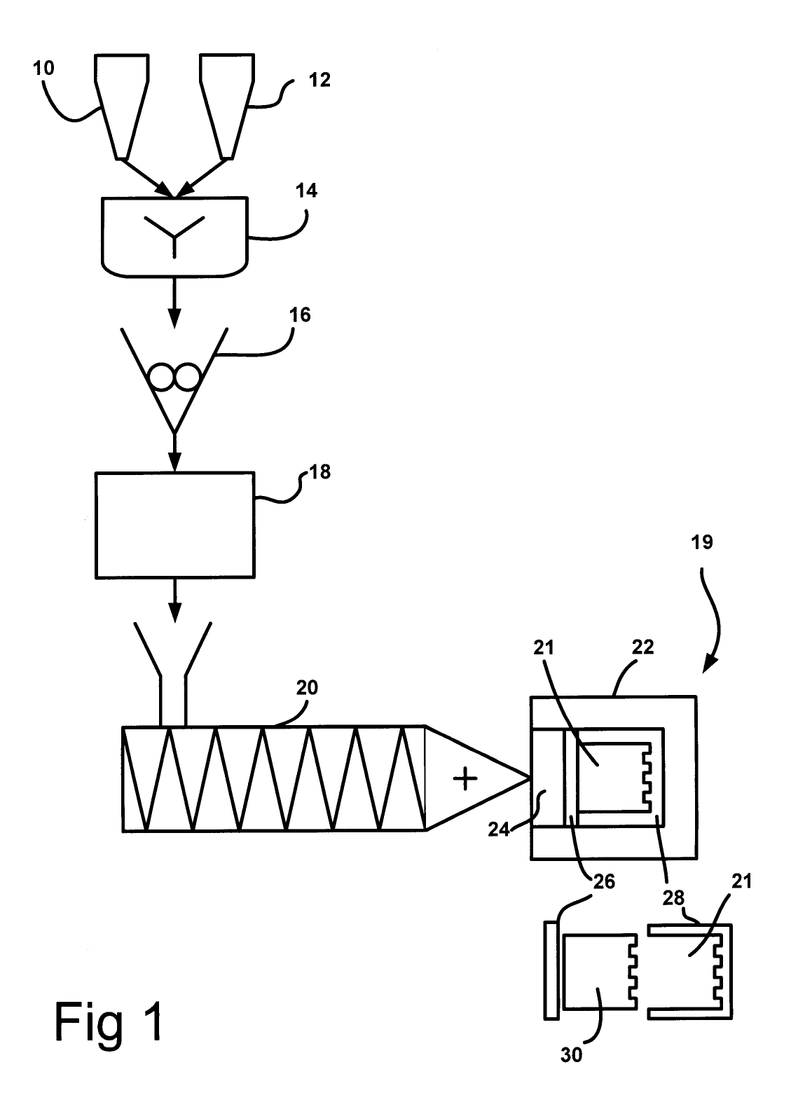

Referring to FIG. 1, the process of using powdered material to form a production part is described. In one embodiment, metal or ceramic 10 and binder 12 are mixed using mixer 14. In one embodiment, heat is applied to the metal or ceramic and binder during the mixing process. The resulting mixture is ground through grinder 16, resulting in feedstock 18. When metal is used in the feedstock, elemental or pre-alloyed metal powders having particle sizes of less than 30 microns are used. This mixture is then cooled and finely granulated, and the resulting feedstock is used in subsequent steps.

Once the feedstock is prepared, the feedstock can be used to produce a “green part” that can be further processed. For example, the feedstock can then be heated and placed into an injection molding machine 20 which injects the feedstock into a metal injection mold shown generally at 19. In one embodiment, the injection mold includes a first member 22 (e.g., cavity or core) and a second member 24 (cover or ejector). A mold cavity 21 is defined by said first and second mold members. First mold insert 28 is carried by the first member and a second mold insert 26 is carried by the second mold member. Microstructures can be carried by all or part of the surface exposed to the mold cavity, thereby producing microstructured features on the final metal injection molded part. In molding, the feedstock is heated until it is able to flow and then injected under pressure into the mold cavity and allowed to cool and solidify. Once cooled and solidified, the produced “green part” 30 is ejected (demolded) from the mold cavity and now has microstructured features on its surface corresponding to the microstructured mold inserts.

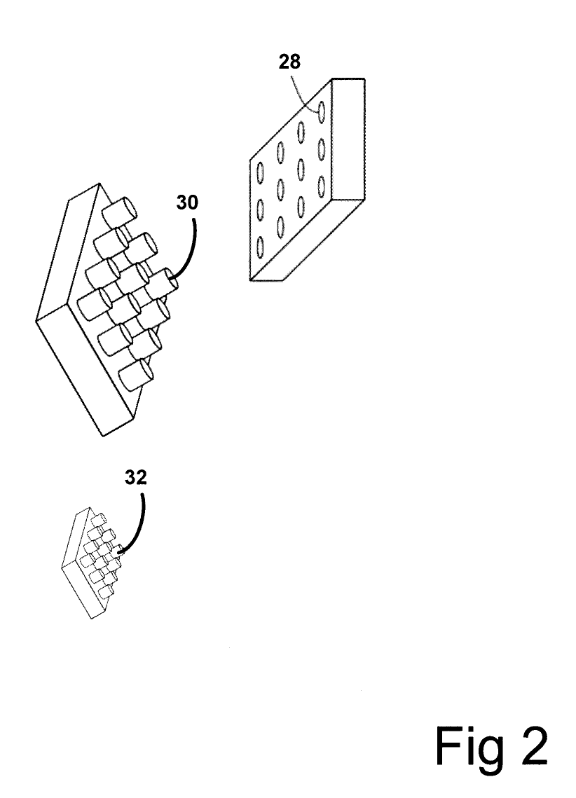

The first and second mold inserts can be manufactured by the process stated in U.S. patent application Ser. No. 12/813,833 and the methods and processes described in the patent applications for which it claims priority, all of which are incorporated herein by reference. The mold insert can have a negative 28 (FIG. 2) of the final microstructured features that will be present on the “green part” 30.

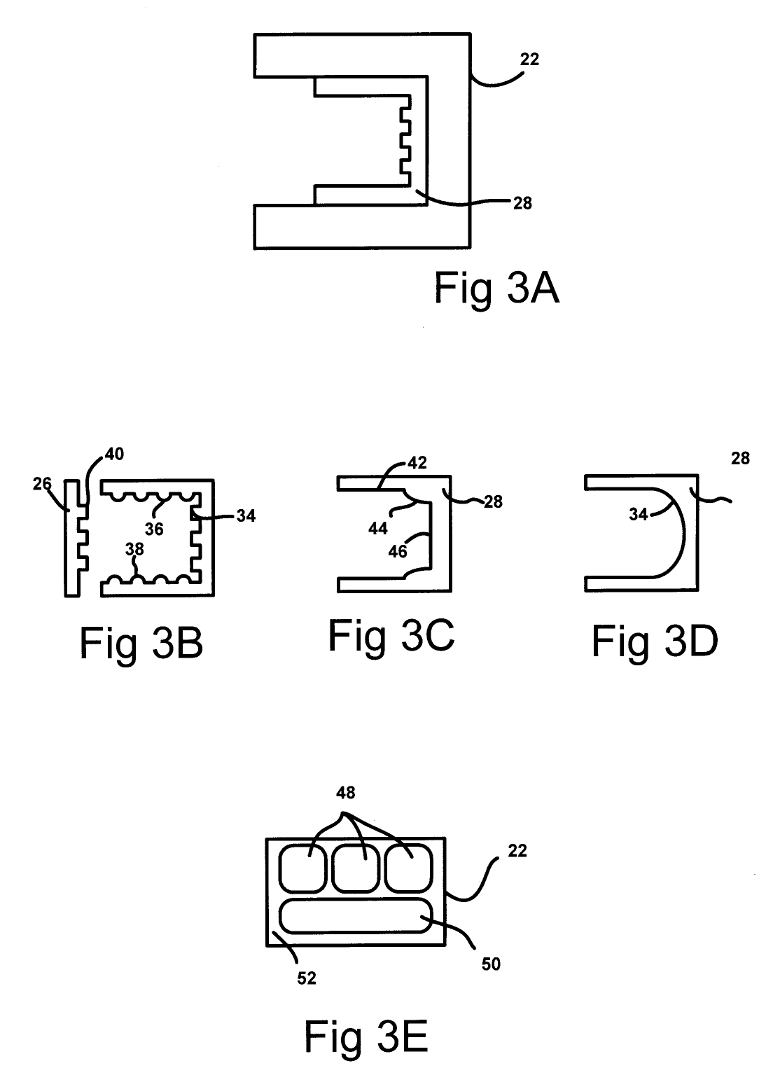

Referring to FIG. 3, various mold inserts are illustrated. In one embodiment, a uniform microstructured pattern is present along the entire surface of the mold insert exposed to the mold cavity. In one embodiment, the mold insert 28 has microfeatures on its surface less than the entire inner surface exposed to the mold cavity so that the final part only has microstructured features on a portion of the final part. In one embodiment, the mold inserts contain a plurality of different microstructured features on several differing areas of the mold insert such as a first microstructured feature 34, a second microstructured feature 36, a third microstructured feature 38, and a fourth microstructured feature 40, allowing for a plurality of microstructured features to be imparted on the final part. In one embodiment, the mold insert surfaces can include curves shown as 34 and 44. In this embodiment, and since the mold insert is flexible, a polymer intermediate can be attached to the mold insert, conforming to the existing mold insert shape and result in a final part having microstructured features on a curved surface. Further, different microstructured features can be included on the mold insert such as a flat microstructured feature 42 and 46 adjacent to a curved microstructured feature 44 carried by the mold and provided by the flexible polymer insert.

In one embodiment, the flexible polymer intermediate can be non-contiguous to the mold insert and contain areas of one microstructured feature 48, a second microstructured feature 50 and a non-microstructured area 52. The flexible polymer intermediate can be made from PDMS, PMMA, PTFE, polyurethanes, Teflon, polyacrylates, polyarylates, thermoplastics, thermoplastic elastomers, fluoropolymers, biodegradable polymers, polycarbonates, polyethylenes, polyimides, polystyrenes, polyvinyls, polyoelefins, silicones, natural rubbers, synthetic rubbers, and any combination of these.

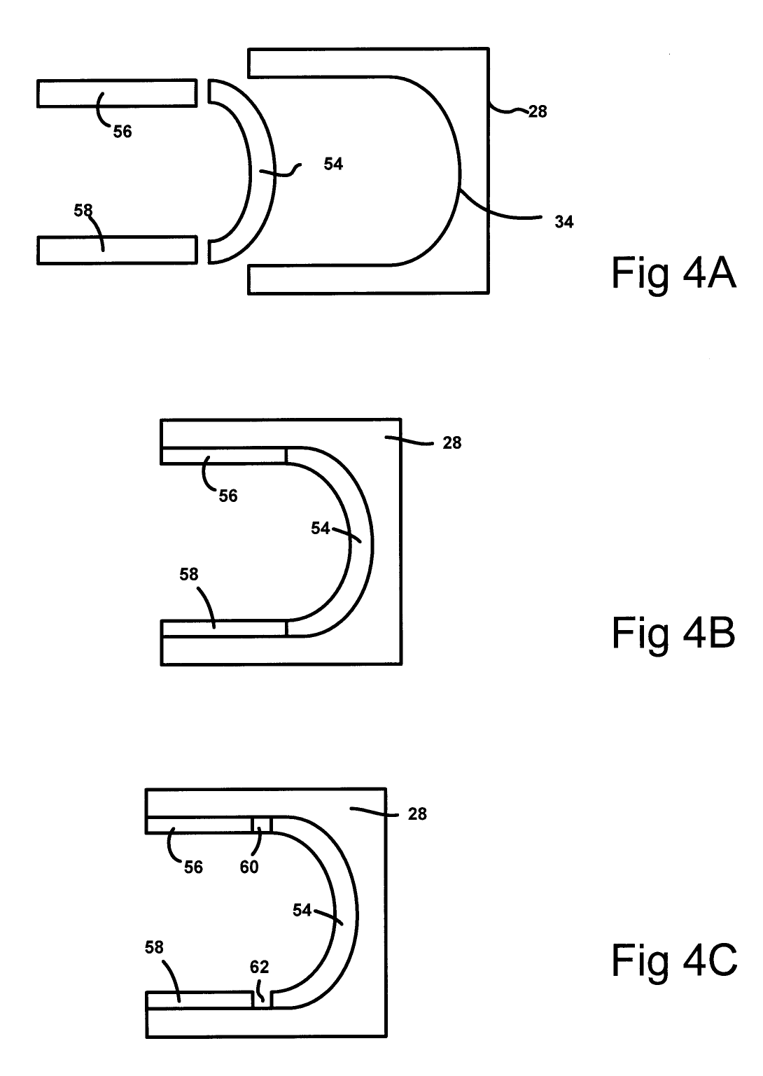

Referring to FIG. 4, the flexible polymer intermediate can be manufactured in sections (tiles) such as a first tile 56, a second tile 58 and a third tile 54. These flexible polymer intermediate tiles can be carried by a cured mold insert 28. In one embodiment, the non-microstructured areas can be included on the flexible intermediate shown as 60 as well as voids in the mold as shown as 62 using flexible polymer intermediate tiles. Further, the several microfeatures of the tiles can be of differing dimensions to provide for advantageous pressure resistance for superhydrophobic properties and an advantageous contact angle produced by the microstructured features.

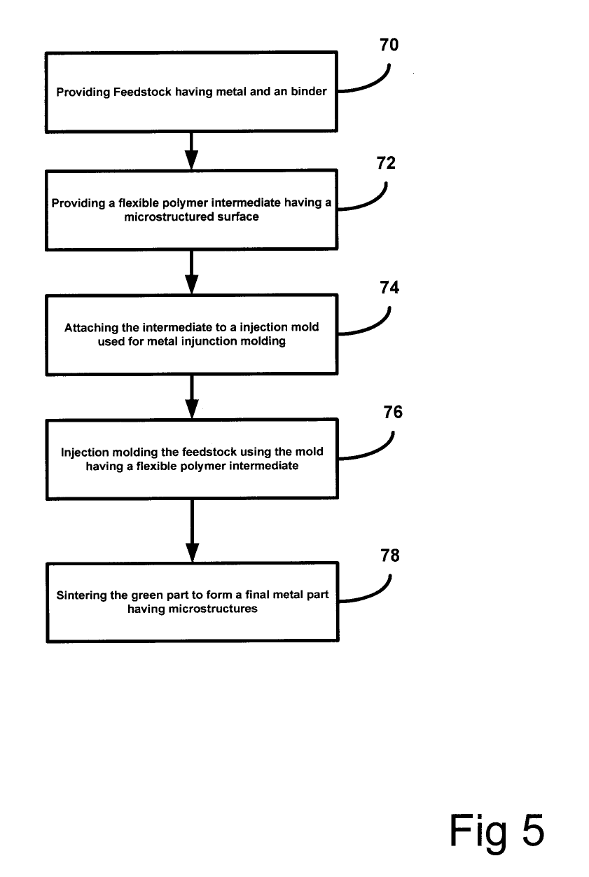

Referring to FIG. 5, the invention is explained by using powered metal as an example. Feedstock is provided having a metal and binder at step 70, providing a flexible polymer intermediate having a microstructured surface at 72, attaching the flexible polymer intermediate to the mold insert at 74, injection molding a “green part” using the feedstock at 76 and manufacturing a final metal part having microstructures features at 78. It should be noted that instead of powered metal, powered material including a ceramic can be used.

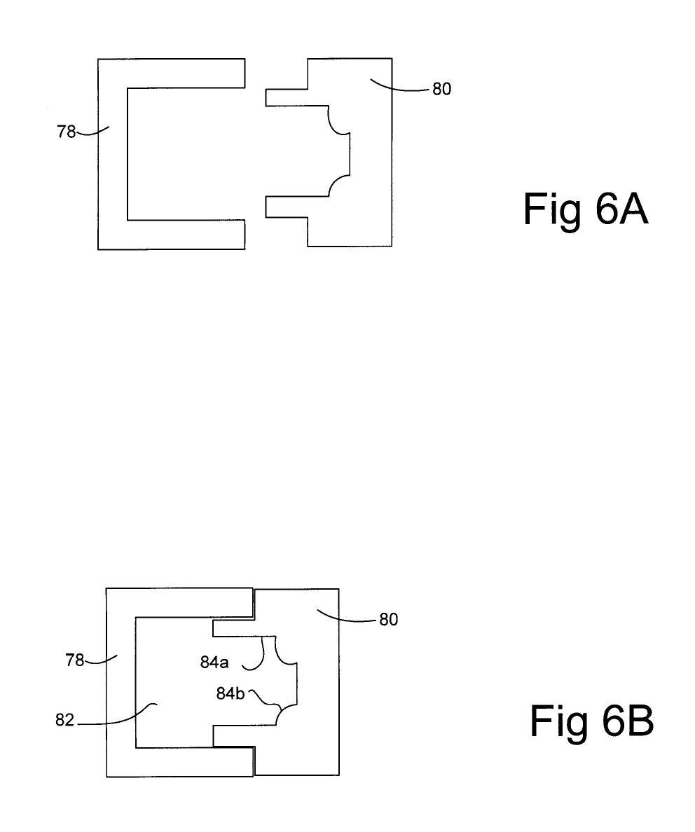

Referring to FIG. 6, one embodiment using compression molding is shown. A first compression member 78 and second compression member 80 are shown defining a cavity 82. The powdered material is placed into the mold cavity and through pressure and sometimes heat, the “green part” is shaped to the mold cavity. The portions of the surface of the first and second compression members, shown by example as 84a and 84b, can carry a flexible polymer intermediate that has microstructured features that are imparted onto the molded “green part”. The “green part” can be removed from the mold and in one embodiment, sintered to form a production part after debinding.

In one embodiment, powdered material can be formed into sheets or strips. The powdered material, generally having a binder to provide for a sufficient structural integrity for the powdered material, can be processed by roll forming. The strip or sheet of powdered material 84 is forced through rollers 86a and 86b to compress the powdered material. The rollers can have flexible polymer inserts carried by a portion or all of the outer diameter of the rollers to impart microstructures onto the powdered material. The rollers can have curved areas other than the outer diameter which can carry a flexible polymer intermediate. The resulting “green part” can then be debound and sintered.

In one embodiment, the powdered material, or resulting “green part”, can have microstructured features imparted on it by stamping. Powdered materials or a “green part” in sheet or strip form, can be stamped or embossed by manufacturing tool 92. The manufacturing tool can include a curved surface 94 that allows a flexible polymer intermediate to conform to the curved surface. Embossing of microstructured features onto a powdered material or “green part” can be performed by rollers or stamps.

The “green part” undergoes debinding to remove the binder from the “green part”. Typically, this is performed by heating the “green part”, thereby evaporating the binder from the “green part”. The next step is to heat the “green part” at relative high temperatures to allow for diffusional flow of the metal which causes densification of the part. When densification occurs, pores are eliminated from the part and the part shrinks. The finished part retains the original complex shape of the molded part and, therefore, retains the microstructured surface features. The surface features can produce physical properties that include hydrophobicity, hydrophilicity, self-cleaning ability, hydro-dynamics drag coefficients, aerodynamic drag coefficients, frictional properties, optical effects, and any combination of these.

In one embodiment, the flexible polymer intermediate remains on the “green part” when the “green part” is removed from a mold cavity, exits rollers or is stamped. The flexible polymer intermediate can then be removed during the debinding process so that the microstructured features on the “green part” are not damaged, or affected, by the physical removal of the “green part” from the mold cavity. Further, the flexible polymer intermediate can provide an added benefit by protecting the microstructured features until the debinding process.

The present invention allows for the manufacturing of a metal part using a mold, mold insert, roller mold, or stamp having a curved area, both convex and concave. The curved area can have a flexible polymer intermediate having microstructures carried by the curved areas.

When using a flexible polymer intermediate, the intermediate has a negative of the microstructured features desired on the final part. In one embodiment, the “green part” contains microfeatures that are elliptical pillars with 50 μm major axis, 25 μm minor axis, height of 50 μm, and spacing of 50 μm. In one embodiment, the final part maintained approximately the same aspect ratio between the major axis and minor axis and the height and spacing as the “green part”.

It is notable that the present invention can result in final parts or can result in metal molds used to manufacture other parts. For example, the present invention can result in the manufacture of molds and tools for compression molding, embossing, forging molds, stamping tools, extruding dies, printing plates, drawing tools and finishing tools. Further, the production part can include a final part, a second intermediate, mold, stamp or other part.

The present invention provides significant advantages over the prior art in that the ability to use a flexible polymer intermediate provides for the molding of a curved surface and the ability to tile a plurality of flexible polymer intermediates onto a manufacturing part. Further, the ability to place multiple flexible polymer intermediates onto a manufacturing part allows the manufacturing process to generate production parts much larger than with silicon wafers thereby overcoming a significant size limitation inherent to silicon.

What is claimed is:

1. A method of manufacturing a production part having microstructured features comprising the steps of:
fabricating a microstructured prototype having microstructured features;
manufacturing a flexible microstructured intermediate from said microstructured prototype so that said microstructured intermediate carries a negative of said microstructured features;
attaching said microstructured intermediate to a manufacturing tool thereby providing microstructured features on a manufacturing tool;
providing feedstock containing material from the group comprising of: metal, ceramic, binder, and any combination of these; and,
manufacturing said production part from said feedstock, using said manufacturing tool and using a process from the group consisting of: compression molding, roll forming, stamping, embossing, extrusion injection molding, and any combination of these.

2. The method of claim 1 wherein said flexible polymer intermediate is formed from a material from the group consisting of: thermoplastic, thermoplastic polymer, and rubber.

3. The method of claim 1 including the step of conforming said flexible microstructured intermediate to a curved portion of said manufacturing tool.

4. The method of claim 1 wherein said manufacturing tool is a metal injection mold.

5. The method of claim 4 wherein said step of attaching said microstructured intermediate to said manufacturing tool includes the step of attaching said microstructured intermediate to an injection mold insert and attaching said injection mold insert to an injection mold.

6. The method of claim 1 including the step of creating a production part using said manufacturing part having surface properties selected from the group consisting of: hydrophobicity, hydrophilicity, self-cleaning ability, hydro-dynamics drag coefficients, aerodynamic drag coefficients, frictional properties, optical effects, heat transfer, adhesion, discrete surface area, discrete surface volume, nucleation, cavitation, lubrication, cell growth properties, anti-biofilm growth, tissue adhesion, crack initiation resistance, and any combination of these.

7. The method of claim 1 wherein said microstructured features are selected from the group consisting of: holes, pillars, steps, ridges, curved regions, and any combination of these.

8. The method of claim 1 wherein the step of manufacturing said production part includes sintering said processed feedstock to form said production part.

9. The method of claim 1 including attaching a plurality of flexible polymer intermediates to said manufacturing tool where each of said flexible polymer intermediates have unique microstructured features.

10. The method of claim 9 wherein said plurality of flexible polymer intermediates are attached to said manufacturing tool in a non-contiguous arrangement.

11. The method of claim 1 wherein said plurality of flexible polymer intermediates define a space on said manufacturing tool devoid of microstructured features.

12. The method of claim 1 including the steps of:
ejecting a “green part” and said flexible polymer intermediate from an injection mold whereby said flexible polymer intermediate is carried by said “green part” after ejection; and,
removing said flexible polymer intermediate from said “green part” by debinding.

13. The method of claim 1 including attaching a plurality of flexible polymer intermediates to said manufacturing tool in a tiled arrangement.

14. The method of claim 1 including:
attaching a plurality of flexible microstructured intermediates to said manufacturing tool and attaching a plurality of secondary flexible microstructured intermediates to said manufacturing tool wherein said microstructured features of said secondary flexible microstructured intermediates have differing microstructured features from said flexible microstructured intermediates.

15. The method of claim 14 wherein said plurality of flexible microstructured intermediates and said secondary flexible microstructured intermediates are arranged in an alternating configuration.

16. A manufacturing tool for manufacturing a production part comprising:
a substrate used in a manufacturing process from the group consisting of: compressing molding, roll forming, stamping, embossing, extrusion, injection molding, and any combination of these; and,
a flexible polymer intermediate having a negative of microstructured features included along a surface of said flexible polymer intermediate carried by said substrate.

17. The manufacturing tool of claim 16 including a second flexible polymer intermediate having a negative of second microstructured features carried by said substrate so that a resulting production part manufactured using said substrate will have a plurality of microstructured features.

18. The manufacturing tool of claim 16 including a plurality of flexible polymer intermediates carried by said substrate in a tile arrangement.

19. The manufacturing tool of claim 16 wherein said substrate includes a curved surface.

20. The manufacturing tool of claim 16 including a plurality of flexible polymer intermediates carried by said substrate in a non-contiguous arrangement.

21. The manufacturing tool of claim 16 wherein said microstuctured features cause a production part manufactured using said manufacturing tool to have surface properties selected from the group consisting of: hydrophobicity, hydrophilicity, self-cleaning ability, hydro-dynamics drag coefficients, aerodynamic drag coefficients, frictional properties, optical effects, heat transfer, adhesion, discrete surface area, discrete surface volume, nucleation, cavitation, lubrication, cell growth properties, anti-biofilm growth, tissue adhesion, crack initiation resistance, and any combination of these.

22. The manufactured part of claim 16 wherein said flexible polymer intermediate is manufactured from a microstructured prototype manufactured by providing a semiconductor wafer, patterning said semiconductor wafer with a negative of said microstructures, molding an uncured flexible polymer to the patterned semiconductor wafer, curing the polymer, thereby forming a microstructured flexible polymer having said microstructured features, removing said microstructured flexible polymer from said patterned semiconductor wafer and deforming at least a portion of said microstructured flexible polymer so as to conform the microstructured flexible polymer to at least a portion of the surface of the one or more macro scale features of said flexible polymer intermediate.

23. The manufacturing tool of claim 16 wherein said flexible polymer intermediate comprises a polymer selected from the group consisting of: PDMS, PMMA, PTFE, polyurethanes, Teflon, polyocrylates, polyorylates, thermoplastics, thermoplastic elastomers, fluoropolymers, biodegradable polymers, polycarbonates, polyethylenes, polyimides, polystyrenes, polyvinyls, natural rubber, synthetic rubber, and any combination of these.

24. A method of manufacturing a production part having microstructured features comprising:
transferring microstructured features from a flexible polymer intermediate carried by a manufacturing tool onto a feedstock;
debinding said feedstock; and,
sintering said feedstock to provide a production part having microstructured features.

25. The method of claim 24 wherein transferring microstructured features includes transferring microstructured features from a plurality of flexible polymer intermediates carried by said manufacturing tool.

26. The method of claim 24 wherein transferring microstructured features includes transferring microstructured features from a plurality of flexible polymer intermediates carried by said manufactured tool in a tile arrangement.

27. The method of claim 24 wherein transferring microstructured features includes transferring microstructured features from a flexible polymer intermediate carried by a manufacturing tool having a curved surface.

28. The method of claim 24 including providing said feedstock wherein said feedstock includes material taken from the group consisting of: metal, ceramic, binder, and any combination of these.

29. The method of claim 24 including preserving the aspect ratio of said production part having microstructured features during sintering.

30. The method of claim 24 including removing said flexible polymer intermediate from said feedstock during debinding.
